(19) United States
(12) Patent Application Publication
(10) Pub. No.: US 2010/0257065 A1
(43) Pub. Date: Oct. 7, 2010

(54) ENHANCED FRAUD PROTECTION SYSTEMS AND METHODS

(76) Inventors: Shekhar Gupta, Overland Park, KS (US); Mike A. Roberts, Overland Park, KS (US); Anthony Zerillo, Kansas City, MO (US)

Correspondence Address: Woodard, Emhardt, Moriarty, McNett & Henry LLP, 111 Monument Circle, Suite 3700, Indianapolis, IN, 46204-5137, US

(21) Appl. No.: 12/416,949

(22) Filed: Apr. 2, 2009

(51) Int. Cl. G06Q 20/00; H04W 4/00

(52) U.S. Cl. 705/17; 455/466

(57) ABSTRACT

Systems and methods are disclosed for providing fraud protection for purchases of goods and/or services. Embodiments of the fraud protection systems and methods include communicating with the owner of the financial account offered to pay for the goods and/or services during the purchase approval process to obtain authorization for the purchase from the payment account owner. Other embodiments include sending text messages to the account owner's wireless telephone to approve purchases made over the internet Still other embodiments include sending encrypted messages to the payment account owner, while other embodiments include receiving encrypted messages from the payment account owner. Further embodiment include evaluating whether an online purchase is being made from an IP address associated with the payment account's owner.

### FIELD

Embodiments of this invention relate generally to fraud protection during transactions where a prospective purchaser offers a financial account to make a purchase.

### BACKGROUND

Financial institutions, such as banks and credit card companies, and individuals who keep money in accounts with these financial institutions are interested in ensuring that monies from these accounts are used to purchase goods and/or services only with the account owner's authorization. To protect against fraudulent purchases, financial institutions implement procedures to verify that a person offering an account to make a purchase is authorized by the account's owner to use the account. However, people are still able to fraudulently purchase goods and/or services using accounts these people are not authorized to use. Consequently, there is a need for enhanced fraud protection during purchases to minimize a person's ability to fraudulently purchase goods or services using an account the person is not authorized to use. Certain preferred features of the present invention address these and other needs and provide other important advantages. Some or all of these features may be present in the corresponding independent or dependent claims, but should not be construed to be a limitation unless expressly recited in a particular claim.

### SUMMARY

Embodiments of the present invention provide enhanced fraud protection systems and methods. In accordance with an aspect of embodiments of the present invention, a system for authorizing a purchase is provided. The system includes a fraud protection computer with a processor and a memory device, the memory device including a searchable database with communication device addresses for owners of payment accounts that sellers will accept for payment of goods or services. The system further includes a communication network connecting the fraud protection computer to the communication devices of the payment account owners; wherein the fraud protection computer receives a request to verify whether the owner of a payment account being used to purchase the goods or services authorizes the purchase, the request including information usable by the fraud protection computer to identify the communication device address associated with the owner of the payment account being used to purchase the goods or services; wherein the fraud protection computer searches the database and identifies the communication device address associated with the owner of the payment account being used to purchase the goods or services; wherein the fraud protection computer initiates a message to the payment account owner's communication device address through the communication network, the message requesting the user of the payment account owner's communication device to authorize the purchase by sending a response; and wherein the fraud protection computer determines whether a response received from the payment account owner's communication device indicates that the purchase is authorized by the user of the payment account owner's communication device.

In accordance with another aspect of embodiments of the present invention, a method is provided. The method includes obtaining information identifying a payment account from a prospective purchaser while the prospective purchaser is attempting to purchase goods or services over the internet and searching a database with a computer for the telephone number of a telephone associated with the owner of the payment account offered for purchase. The method further includes sending a message to the telephone associated with the owner of the payment account offered for purchase requesting the telephone's user to appropriately respond to the message if the purchase is authorized, approving the purchase if at least an appropriate response is received, and denying the purchase if an appropriate response is not received.

In accordance with still another aspect of embodiments of the present invention, a method including receiving information identifying a payment account offered by a prospective purchaser when attempting to make a purchase is provided. The method further includes identifying a communication device address associated with the owner of the payment account offered for purchase, the identifying being done with a computer and independently of receiving the communication device address directly from the prospective purchaser during the purchase request; sending a message to the communication device associated with the owner of the payment account offered for purchase; and requesting a response from the communication device associated with the owner of the payment account offered for purchase. The method also includes authorizing the purchase if at least a response corresponding to criteria established before the receiving is received; and denying the purchase if a response corresponding to criteria established before the receiving is not received.

This summary is provided to introduce a selection of the concepts that are described in further detail in the detailed description and drawings contained herein. This summary is not intended to identify any primary or essential features of the claimed subject matter, nor is it intended to be used as an aid in determining the scope of the appended claims. Each embodiment described herein is not intended to address every object described herein, and each embodiment does not include each feature described. Other forms, embodiments, objects, advantages, benefits, features, and aspects of the present invention will become apparent to one of skill in the art from the detailed description and drawings contained herein.

### BRIEF DESCRIPTION OF THE DRAWINGS

FIG. 1 depicts a computer system suitable for use with at least one embodiment of the present invention.

FIG. 2 depicts an enhanced fraud protection system and/or method according to one embodiment of the present invention.

FIG. 3 depicts another enhanced fraud protection system and/or method according to one embodiment of the present invention.

### DETAILED DESCRIPTION OF THE ILLUSTRATED EMBODIMENTS

For the purposes of promoting an understanding of the principles of the invention, reference will now be made to the selected embodiments illustrated in the drawings and specific language will be used to describe the same. It will nevertheless be understood that no limitation of the scope of the invention is hereby intended, such alterations, modifications, and further applications of the principles of the invention being contemplated as would normally occur to one skilled in the art to which the invention relates. At least one embodiment of the invention is shown in great detail, although it will be apparent to those skilled in the relevant art that some features or some combinations of features may not be shown for the sake of clarity.

### DEFINITIONS

Payment account: an account a seller will accept for payment during a purchase, for example, a credit card or bank account.

Communication network: a network providing communication between a payment processing and/or fraud protection agency and an owner of a payment account. Example communication networks include wireless networks, such as mobile telephones (e.g., “cellular” telephones) with or without data capabilities (e.g., Short Message Service (SMS) or Multimedia Messaging Service (MMS) capabilities). Other example communication networks include wired networks such as publicly switched telephone (“land line”) networks. Still other example communication networks include the internet with or without dedicated transmission lines (e.g., T1, T3, or OC3).

Communication device: a device used to communicate on a communication network. Example communication devices include digital telephones, analog telephones, wireless telephones (such as those implementing GSM and/or CDMA technology) with and without data (e.g. “texting”) capabilities, wireless email devices, wired (“land line”) telephones, telephones communicating using the internet (e.g., voice over internet protocol (VoIP) telephones).

Communication device address: the information identifying a particular communication device and used to direct a message to the particular communication device. Example communication device addresses include telephone numbers and email addresses.

Payment processing agency: the agency determining whether to approve or deny use of a payment account for a purchase. Example payment processing agencies include credit card authorization services and online purchase services such as PayPal®.

Fraud protection agency: the agency that attempts to contact the owner of the payment account to determine whether the owner authorizes use of the payment account for a purchase.

Encrypted message: a message sent to a communication device and intended to be inaccessible or unreadable by a person other than the intended recipient of the encrypted message. Example encrypted messages include passcode protected messages, such as text messages that are readily understood by anyone but are sent to a wireless telephone and require the user of the wireless telephone to enter a password to view the message. Another example encrypted message includes a message that can be viewed by anyone, but the content of the message is understood only by someone who understands the code, such as a text message comprising a password that only the intended recipient should understand.

Non-encrypted message: a message sent to a communication device and intended to be accessible and readable by any user of the communication device, which includes persons who are not the communication device's owner.

Embodiments of the present invention provide enhanced fraud protection using communication devices. During the purchase authorization process and before a purchase is approved, the payment processing agency contacts the payment account owner's communication device and requests a response indicating whether the purchase is authorized or not. If the appropriate response is received from the payment account owner's communication device, the purchase is considered to be authorized by the account owner and the purchase is approved, provided any additional authorization checks that may be performed indicate approval. If the appropriate response is not received, or if any additional authorization checks indicate denial of the purchase, the purchase is denied.

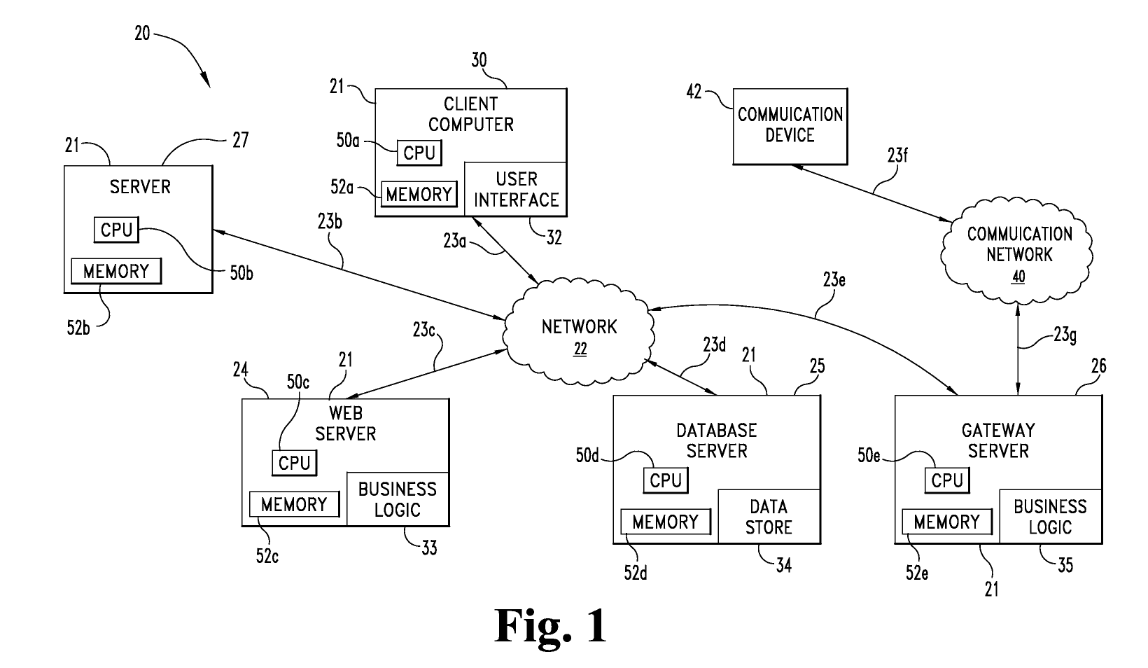

FIG. 1 depicts a computer system 20 suitable for use in at least one embodiment of the present invention. Computer system 20 includes a computer network 22. Computer network 22 couples together a number of computers 21 over network pathways 23a-23e. Communication network 40 couples together gateway server 26 and communication device 42 over pathways 23f and 23g. Pathways 23 may be traditional publicly switched telephone network connections, digital lines (such as T1, T3, OC3), or any other transmission medium suitable for carrying content, such as a wireless or cellular network.

System 20 includes several servers, namely web server 24, database server 25, and gateway server 26. System 20 also includes a client computer 30, for example a computer used by an account owner, which may be located at the account owner's residence or elsewhere, or by a seller of goods and/or services. Still further, system 20 includes server 27, for example the server of a payment processing agency or a server of another entity on the internet. While computers 21 are each illustrated as being a server or client, it should be understood that any of computers 21 may be arranged to include both a client and server. Furthermore, it should be understood that while five computers 21 are illustrated, more or fewer may be utilized in alternative embodiments. In particular, it shall be appreciated that a large number of client computers, such as client computer 30, may be in use within system 20 for performing operations such as allowing numerous individual entities to connect to web server 24.

Computers 21 include one or more processors or CPUs (50a, 50b, 50c, 50d and 50e respectively) and one or more types of memory (52a, 52b, 52c, 52d and 52e respectively). Each memory 52a-52e optionally includes a removable memory device. Each processor 50a-50e optionally includes one or more components configured as a single unit. Alternatively, when of a multi-component form, a processor 50a-50e may have one or more components located remotely relative to the others. One or more components of each processor 50a-50e may be of the electronic variety defining digital circuitry, analog circuitry, or both. In one embodiment, each processor 50a-50e is of a conventional, integrated circuit microprocessor arrangement, such as one or more PENTIUM 4 or XEON processors supplied by INTEL Corporation of 2200 Mission College Boulevard, Santa Clara, Calif. 95052, USA.

Each memory 52a-52e (removable or generic) is one form of a computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

Although not shown, each computer 21 can be optionally coupled to a display and/or includes an integrated display. Computers 21 may be of the same type, or a heterogeneous combination of different computing devices. Likewise, displays may be of the same type, or a heterogeneous combination of different visual devices. Although not shown, each computer 21 may optionally include one or more operator input devices such as a keyboard or mouse to name just a few representative examples. Also, besides a display, one or more other output devices, such as a printer, may be optionally included with each computer 21. As such, various display, input and output device arrangements are possible.

Computer network 22 can be in the form of a wireless or wired Local Area Network (LAN), Municipal Area Network (MAN), Wide Area Network (WAN), such as the internet, a combination of these, or such other network arrangement as would occur to those skilled in the art. In a further form, several computers 21, such as web server 24, database server 25, and gateway server 26 may be coupled together by a secure portion of network 22 while remaining connected to client computer 30 via an unsecured portion of network 22. The operating logic of system 20 can be embodied in signals transmitted over network 22, in programming instructions, dedicated hardware, or a combination of these. It should be understood that more or fewer computers 21 can be coupled together by computer network 22.

In one embodiment, system 20 operates at one or more physical locations where web server 24 is configured to host application business logic 33 for an enhanced fraud protection service, database server 25 is configured to store information that can be used to identify the communication device address of a payment account owner on data store 34, and client computer 30 is configured for providing a user interface 32, for allowing a representative of an entity of interest to interact with the service, such as to enter user information, create/upload content segments, and/or initiate/manage the distribution of a batch of communications. It shall be appreciated that in alternate forms client computer 30 may be any web-enabled device, such as a cellular telephone, PDA or Blackberry®, to name just a few illustrative examples. Furthermore, user interface 32 of client computer 30 may be an installable application, such as one that communicates with web server 24, browser-based, and/or embedded software, to name a few non-limiting examples. In one embodiment, software installed locally on client computers 30 is used to communicate with web server 24. In another embodiment, web server 24 provides HTML pages, data from web services, and/or other internet standard or company proprietary data formats to one or more client computers 30 or servers 27 when requested. One of ordinary skill in the art will recognize that the term web server is used generically for purposes of illustration and is not meant to imply that network 22 is required to be the internet.

In the illustrated example embodiment, gateway server 26 includes business logic 35 and associated hardware providing the ability to send automated messages to payment account owner communication devices. For example, gateway server may include operation as an autodialer or a predictive dialer for distributing content to one or more select users retrieved from database server 25 and data store 34. Gateway server 26 can initiate a communication session with communication device 42 via communication network 40. It should be appreciated that more than one communication device can be included in use of system 20, but that only one has been shown to preserve clarity. Further, it should be appreciated that the types of communication devices connected to system 20 need not be of the same type, but that digital, analog, and other technologies may be accommodated simultaneously.

Typical applications of system 20 include three servers, such as web server 24, database server 25, and gateway server 26, but it will be appreciated by those of ordinary skill in the art that the one or more features provided by those servers could be provided by a single computer or varying other arrangements of computers at one or more physical locations and still be within the spirit of the invention.

In one example embodiment represented by FIG. 1, a single agency performs both payment processing and fraud protection functions. The single agency includes web server 24, database server 25, and gateway server 26, with server 27 being operated by another entity on the internet.

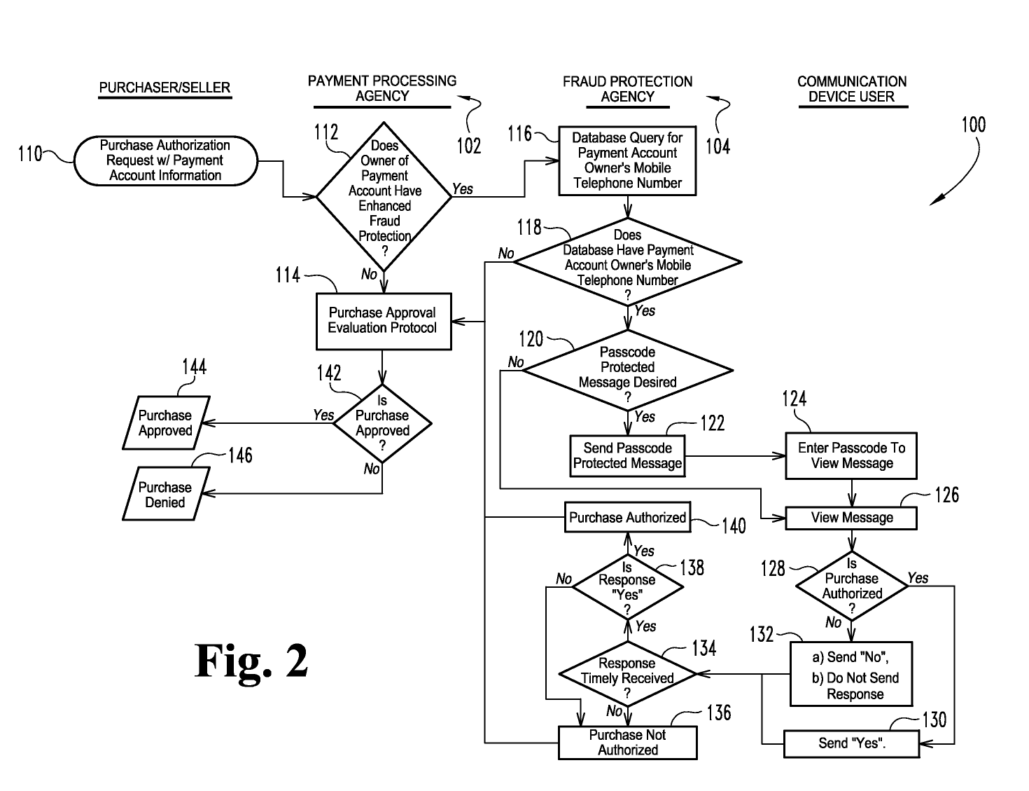

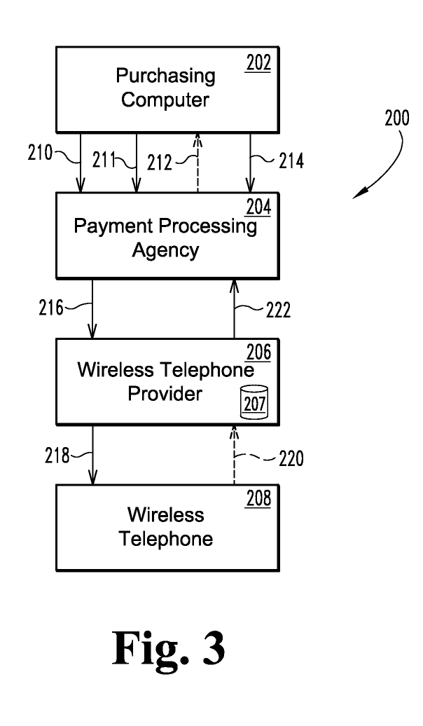

In another example embodiment also represented by FIG. 1, a payment processing agency includes server 27 and communicates via network 22 with a fraud protection agency, where the fraud protection agency includes web server 24, database server 25 and gateway server 26. Example payment processing agencies include the payment processing agency 102 depicted in FIG. 2 and the payment processing agency 204 depicted in FIG. 3; and example fraud protection agencies include the fraud protection agency 104 depicted in FIG. 2 and the wireless telephone provider 206 depicted in FIG. 3.

Turning to FIG. 2, depicted is an example embodiment enhanced fraud protection system and/or method 100 that can be implemented using the system 20 depicted in FIG. 1. When a purchaser desires to purchase goods and/or services from a seller, a purchase authorization request 110 is initiated and sent to the payment processing agency 102. The purchase authorization request 110 includes information identifying the payment account the purchaser offers to pay for the goods and/or services. If the purchase authorization request 110 does not include payment account information, the purchaser will be asked to provide this information. Using the system 20 depicted in FIG. 1 as an example, the purchaser could use a client computer 30, and communicate with the server 27 at the payment processing agency via network 22.

Returning to FIG. 2, after receiving the purchase authorization request 110, the payment processing agency 102 determines whether the monies in the payment account may be used for the purchase. The transmission of the purchase authorization request 110 can be made directly by the prospective purchaser, such as when attempting to make a purchase over the internet (online), or by the seller, such as when a credit card is offered to a seller who transmits the purchase authorization request 110 to the payment processing agency 102.

Initially, the payment processing agency 102 determines whether enhanced fraud protection is a service associated with the payment account (item 112). Enhanced fraud protection can be provided as part of a payment account's standard terms and conditions, or enhanced fraud protection can be an additional feature added to a payment account when the account's owner registers for the service, typically for an additional fee. The enhanced fraud protection provided by embodiments of the present invention may also be provided as a service after an individual's identify has been stolen.

If the payment processing agency 102 determines that the payment account is not supposed to receive enhanced fraud protection, the payment processing agency 102 initiates its standard purchase approval evaluation protocol 114. Payment processing agency 102 will typically run protocol 114 to determine whether a payment account may be used for a purchase, and may be run independently of or in concert with enhanced fraud protection embodiments herein described. Protocol 114 may ensure that the payment account is in good standing or that the prospective purchase will not exceed the monies in the payment account or exceed the account's limits for total debt incurred.

If the payment processing agency 102 determines that the payment account offered to purchase the goods and/or services is to receive enhanced fraud protection, the payment processing agency 102 requests a fraud protection agency 104 to verify whether the owner of the payment account authorizes use of the payment account for the prospective purchase. Using the system 20 depicted in FIG. 1 as an example, the payment processing agency could include server 27, and communicate with the fraud protection agency, which includes web server 24, database server 25, and gateway server 26, via network 22.

In the example embodiment depicted in FIG. 2, the payment processing agency 102 and the fraud protection agency 104 are separate, with the payment processing agency 102 being an intermediate agency between the purchaser/seller and the fraud protection agency 104. However, in alternate embodiments the payment processing agency 102 and the fraud protection agency 104 are part of the same entity, which receives the purchase request, performs the purchase approval evaluation protocol 114, and contacts the owner of the payment account for purchase authorization.

Upon receiving the request from the payment processing agency 102, the fraud protection agency 104 determines the address of the payment account owner's communication device (communication device address), for example, the payment account owner's mobile telephone number. In the example embodiment depicted in FIG. 2, the fraud protection agency 104 queries a database to determine the payment account owner's mobile telephone number (item 116). (In the example depicted in FIG. 1, this query could be accomplished with database server 25). If the database query does not produce the payment account owner's mobile telephone number (item 118), this result is input into the purchase approval evaluation protocol (114). In alternate embodiments, the inability of the fraud protection agency 104 to locate a communication device address associated with the payment account results in the purchase being denied.

It should be appreciated that the communication device can be any of a number of different types of communication devices that the fraud protection agency 104 is capable of using and with which the payment account's owner desires to be contacted to authorize use of the payment account for a purchase. Advantages are realized if the account owner's communication device is part of a communication network that provides rapid communication between the fraud protection agency 104 and the owner of the payment account offered by the prospective purchaser to make a purchase. Rapid communication allows the authorization process to occur quickly, which allows the purchase to proceed with minimal delays. Decreasing delays imposed on the purchase approval process makes the fraud protection process more attractive for both the payment account owners and the sellers. Mobile telephones provide additional advantages since people generally keep their mobile telephones nearby and readily accessible throughout the day, providing the ability to contact the payment account owner and thwart unauthorized use of the payment account at any time of day. Additionally, mobile telephone networks provide near real-time communication (communication with very little delay). Other embodiments utilize other communication networks that provide expeditious communication, with any communication delays being brief enough to not adversely interfere with the purchasing process.

In the embodiment depicted in FIG. 2, if the database query produces the payment account owner's mobile telephone number (item 118), the fraud protection agency 104 determines whether to send an encrypted message to the payment account owner's mobile telephone (item 120). In the depicted embodiment, the encrypted message is a passcode protected message where the user of the communication device must enter a previously established passcode, such as a password, to obtain the message. Whether the fraud protection agency sends an encrypted or non-encrypted message generally depends on the security level provided to the payment account owner and could be offered as an option to the payment account owner.

Alternate embodiments do not determine whether to send an encrypted message (item 120). Instead, the fraud protection agency 104 sends only encrypted messages to the payment account owner's communication device. In still other embodiments, the fraud protection agency 104 sends only non-encrypted messages to the payment account owner's communication device. Whether the fraud protection agency 104 sends encrypted or non-encrypted messages to the payment account owner's communication device depends on the security level provided to the payment account owner and the ability of the fraud protection agency 104 to send encrypted messages.

If an encrypted message is not desired (item 120), a non-encrypted message is sent to the payment account owner's mobile telephone number and viewed by the user of the payment account owner's mobile telephone (item 126). (In the example depicted in FIG. 1, gateway server 26 could send the message to the payment account owner's communication device 42 via communications network 40).

If an encrypted message is desired (item 120), the fraud protection agency 104 sends, for example, a passcode (e.g., password) protected message to the wireless telephone associated with the payment account (item 122). Upon receiving the password protected message, the user of the payment account owner's mobile telephone is required to enter a previously established password to view the message from the fraud protection agency 104 (item 124). The user of the communication device is then able to view the message (item 126).

In the described embodiment, the time between the fraud protection agency 104 receiving the request from the payment processing agency 102 and the payment account owner's communication device receiving the message from the fraud protection agency 104 is no more than three (3) minutes. In other embodiments, this time is no more than one (1) minute. In still other embodiments, this time is no more than thirty (30) seconds.

The message sent from the fraud protection agency 104 indicates to the mobile telephone user that the payment account is being offered for a purchase and requests a response to authorize the purchase (item 128). In alternate embodiments the default position of the fraud protection agency 104 is to approve the purchase unless the mobile telephone user responds otherwise, which is frequently useful in situations where less heightened fraud protection is desired.

In the described embodiment, the message sent from the fraud protection agency 104 to the account owner's mobile telephone is a text message. In alternate embodiments, the message is another form of message that relays to the account owner that the payment account is being offered to make a purchase and for the account owner to respond to authorize (or not authorize) the purchase, for example, an electronically generated or prerecorded voice message.

To authorize the purchase, the communication device user complies with the instructions in the message sent from the fraud protection agency 104 to authorize the purchase (item 130). The appropriate response to authorize the purchase can take various forms provided the response accurately indicates the wireless telephone user's instructions. In the example embodiment, the appropriate response includes sending the text message “yes” to the telephone number indicated on the message from the fraud protection agency 104. Alternatively, the user of the payment account owner's wireless telephone could send a previously established password to authorize the purchase.

To deny the prospective purchase, the communication device's user complies with the instructions in the message sent from the fraud protection agency 104 for indicating that the purchase is not authorized (item 132). In the depicted embodiment, the mobile telephone user could either send the text message “no” to the telephone number indicated on the message from the fraud protection agency 104, or the mobile telephone user could simply not respond to the message. Since the absence of a response from the mobile telephone indicates that use of the offered payment account is not authorized for the prospective purchase, a person who does not have the payment account owner's mobile telephone is unable to authorize the purchase. In alternate embodiments that require an encrypted response to authorize the purchase, even someone with the payment account owner's mobile telephone is unable to authorize the purchase unless that someone obtained the password from the payment account's owner. Advantages realized with requiring an encrypted message to authorize a purchase include the ability to prevent individuals with access to the account user's communication device, such as the account owner's children, from being able to make purchases, e.g. online purchases, without the account owner's knowledge.

After sending the message requesting authorization from the payment account owner's mobile telephone, the fraud protection agency 104 determines whether a response from the account owner's mobile telephone is received within an established time period (item 134). If a response from the payment account owner's mobile telephone is not timely received, the fraud protection agency 104 notifies the payment processing agency 102 that the prospective purchase was not authorized (item 136).

If, however, the fraud protection agency 104 receives a timely response from the payment account owner's mobile telephone, the fraud protection agency 104 determines whether the response was appropriate for authorizing use of the payment account for the prospective purchase (item 138). If an appropriate response was not received, the fraud protection agency 104 notifies the payment processing agency 102 that the payment account was not authorized for use (item 136). If an appropriate response is received by the fraud protection agency 104, the fraud protection agency 104 notifies the payment processing agency 102 that the payment account is authorized for use to make the prospective purchase (item 140). As indicated above, in alternate embodiments the fraud protection agency 104 and the payment processing agency 102 are the same entity.

The payment processing agency 102 incorporates into the purchase approval evaluation protocol (114) the input from the fraud protection agency 104 indicating whether the prospective purchase is approved or not approved and determines whether the prospective purchase is approved (item 142). The payment processing agency 102 then notifies the purchaser and/or seller that the purchase is either approved (item 144) or denied (item 146) as appropriate.

In alternate embodiments where only fraud protection is required for purchase approval, the purchase approval evaluation protocol (114) is a pass-through operation in which the prospective purchase is approved if the purchase is authorized (as with item 140), or denied if either the database does not have the payment account owner's mobile telephone number (as with item 118) or if the purchase is not authorized (as with item 136).

In the described embodiment, the time between the prospective purchaser and/or seller originating the purchase authorization request 110 and the payment processing agency 102 determining whether the prospective purchase is approved or denied, which includes the maximum time the fraud protection agency 104 waits for a response from the account owner's communication device (item 134), is no more than five (5) minutes. In other embodiments, this time is no more than two (2) minutes. In still other embodiments, this time is no more than one (1) minute.

FIG. 3 depicts another example embodiment enhanced fraud protection system and/or method 200 using a communication network that can be implemented with system 20 depicted in FIG. 1 and provides rapid communication between the payment processing agency and the payment account owner. During sequence 200, a purchaser using purchasing computer 202 attempts to make an online purchase. The purchase attempt includes transmitting a purchase request 210 and information identifying the payment account, for example a credit card number 211, to the payment processing agency 204. (In the example depicted in FIG. 1, the purchase request could be sent by the purchaser using client computer 30, via network 22, to the payment processing agency's server 27). If the purchase request does not include the credit card number 211, the payment processing agency 204 initiates a request 212 for the purchaser to supply the credit card number 211 to the payment processing agency 204.

During the interaction with the purchasing computer 202, the payment processing agency 204 receives additional purchaser identifying information from the purchasing computer 202. Example additional purchaser identifying information includes the purchasing computer 202's Internet Protocol (“IP”) address 214 and the purchaser's home address. The purchasing computer 202's IP address 214 may be received by the payment processing agency 204 through purchasing computer 202's DataPOP information.

After receiving the purchase request 210, the payment account information 211, and the IP address 214, the payment processing agency 204 begins an authentication sequence that includes sending an authentication request 216 to an enhanced fraud protection provider, such as a wireless telephone provider 206 with a telephone number database 207 stored on a computer hard drive. The authentication request 216 is sent via a communication network that provides communication with little delay, such as via the internet (online) or a telephone network. The authentication request 216 includes credit card number 211 and additional purchaser identifying information, such as the purchasing computer's IP address 214. (In the example depicted in FIG. 1, the authentication request could be sent by a server 27 of the payment processing agency, via network 22, to the fraud protection provider's web server 24, database server 25, and gateway server 26).

A Line Information Data Base (“LIDB”) is one example of a database 207 that may be used by wireless telephone provider 206. The LIDB includes wireless telephone caller identification (“caller ID”) information and additional identifying information similar to the additional purchaser identifying information received from the purchasing computer 202. For example, if the additional purchaser identifying information is the purchasing computer 202's IP address 214, database 207 will include a wireless telephone customer's caller ID and IP address information. The wireless telephone customer's IP address may, for example, be supplied directly by the wireless telephone provider's customer when establishing service, or the IP address may be obtained from DataPOPs sent to the wireless telephone provider 206 during online communications with the customer, such as the customer accessing the customer's wireless telephone account information online.

After receiving request 216, the wireless telephone provider 206 queries the database 207 to determine whether the credit card number 211 and IP address 214 correlate with a customer's record stored in the database 207. For example, the wireless telephone provider 206 may query database 207 for a record with a credit card number matching the purchaser supplied credit card number 211. Once finding at least one matching record, the wireless telephone provider 206 can determine if the purchasing computer IP address 214 matches the IP address in the matched record. In an alternate embodiment, the wireless telephone provider 206 may query database 207 for a record with an IP address matching the purchaser supplied IP address 214. Once finding at least one matching record, the wireless telephone provider 206 can determine if the credit card number 211 matches the credit card number in the matched record.

If the credit card number 211 and the IP address 214 do not correlate with a customer's record, the wireless telephone provider 206 sends an authentication message 218 to the payment account owner's communication device, such as a wireless telephone 208, requesting a reply from the wireless telephone 208's user. For example, the wireless telephone provider 206 sends a Short Message Service (“SMS”) or Multimedia Messaging Service (“MMS”) message through an SMS or MMS gateway to the prospective purchaser's wireless telephone 208. (In the example depicted in FIG. 1, the wireless telephone provider could use gateway server 26 to send an authentication message via communication network 40 to the payment account owner's communication device 42).

The authentication message 218 can be, for example, a text, pre-recorded voice, or electronically generated voice message indicating that the payment account correlating to credit card number 211 is being used for a purchase. The message 218 further requests that wireless telephone 208's user reply by sending an authentication reply 220 indicating whether the payment account owner authorizes the use of the payment account for the purchase. For example, message 218 can request telephone 208's user to send/text “no” in the authentication reply message 220 to a specified telephone number if the purchase is not valid and send/text “yes” in the authentication reply message 220 if the purchase is valid.

In alternate embodiments, the payment account owner could simply not reply to the authentication message 218 if the purchase is not valid, the default position of the wireless telephone provider 206 being to consider all purchases as not authenticated unless a reply is received from the wireless telephone 208.

In still other embodiments, the authentication message 218 requests that wireless telephone 208's user reply by sending an authentication reply 220 if the use of the payment account is not valid. In this embodiment, the default position of the wireless telephone provider 206 is to consider all purchases authenticated unless a reply is received from the wireless telephone 208.

After receiving the authentication reply message 220, the wireless telephone provider 206 sends the results of the authentication process to the payment processing agency 204 in an authentication results transmission 222. It should be appreciated that the wireless telephone provider 206 may send the results of the authentication process to the payment processing agency 204 after waiting an appropriate amount of time but not receiving an authentication reply message 220 from telephone 208. The authentication results transmission 222 may be a simple “yes” or “no” indication, or may include more detailed information concerning the results of the authentication process.

If the credit card number 211 and the IP address 214 correlate with a customer's record, the purchase is authenticated and the wireless telephone provider 206 sends an authentication result transmission 222 to the payment processing agency 204 indicating that the prospective purchase was authorized. In this embodiment, obtaining a correlation between the purchaser supplied credit card number 211 and the IP address 214 is sufficient to authenticate the purchase. This level of fraud protection may be all that is required for payment account owners who typically purchase from the same IP address, such as the payment account owner's home computer, and have little concern about someone else using their credit card to make purchases from their home computer.

In other embodiments, only the payment account information (for example, credit card number 211) is supplied with the purchase request 210 and supplied to the enhanced fraud protection provider (for example, wireless telephone provider 206) in authentication request 216. The fraud protection provider obtains (for example, from its computer database) the account owner's communication device address (for example, wireless telephone number) and sends a message to the account owner's communication device. The message notifies the payment account owner of the pending purchase, requests a reply to authorize (or deny) the purchase, and may be encrypted or non-encrypted depending on the desired security level.

After receiving authentication results transmission 222 and the results of any additional authenticating protocols the payment processing agency 204 may choose to run, the payment processing agency 204 either approves or disapproves the requested purchase. It should be appreciated that the payment processing agency 204 and the enhanced fraud protection provider, such as wireless telephone provider 206, can be the same entity as opposed to two separate entities.

It should be appreciated that the purchasing computer 202 may belong to the actual purchaser, such as when a person attempts to make an online purchase from their home computer, or may represent a computer the purchaser does not own, such as a computer at a store where the customer is attempting to make a purchase.

The enhanced fraud protection systems and/or methods disclosed herein may be offered to owners of payment accounts or to financial institutions as a stand-alone service, or may be offered as part of a larger authentication and fraud protection service.

While illustrated examples, representative embodiments and specific forms of the invention have been illustrated and described in detail in the drawings and foregoing description, the same is to be considered as illustrative and not restrictive or limiting. The description of particular features in one embodiment does not imply that those particular features are necessarily limited to that one embodiment. Features of one embodiment may be used in combination with features of other embodiments as would be understood by one of ordinary skill in the art, whether or not explicitly described as such. Dimensions, whether used explicitly or implicitly, are not intended to be limiting and may be altered as would be understood by one of ordinary skill in the art. Only exemplary embodiments have been shown and described, and all changes and modifications that come within the spirit of the invention are desired to be protected.

What is claimed is:

1. A system for authorizing a purchase, comprising:
a fraud protection computer with a processor and a memory device, the memory device including a searchable database with communication device addresses for owners of payment accounts that sellers will accept for payment of goods or services; and
a communication network connecting the fraud protection computer to the communication devices of the payment account owners;
wherein
the fraud protection computer receives a request to verify whether the owner of a payment account being used to purchase the goods or services authorizes the purchase, the request including information usable by the fraud protection computer to identify the communication device address associated with the owner of the payment account being used to purchase the goods or services;
the fraud protection computer searches the database and identifies the communication device address associated with the owner of the payment account being used to purchase the goods or services;
the fraud protection computer initiates a message to the payment account owner's communication device address through the communication network, the message requesting the user of the payment account owner's communication device to authorize the purchase by sending a response; and
the fraud protection computer determines whether a response received from the payment account owner's communication device indicates that the purchase is authorized by the user of the payment account owner's communication device.

2. The system of claim 1, wherein the payment account owner's communication device is a wireless telephone and the communications network for sending the message to the payment account owner's wireless telephone is a wireless telephone network.

3. The system of claim 2, wherein the fraud protection computer initiates a text message to the payment account owner's wireless telephone.

4. The system of claim 1, wherein the payment account owner's communication device receives the message requesting the user of the payment account owner's communication device to authorize the purchase no more than one (1) minute after the fraud protection computer receives the request to authorize the purchase of goods and services.

5. The system of claim 1, wherein the fraud protection computer receives the request to verify whether the owner of a payment account being used to purchase the goods or services authorizes the purchase from a purchasing computer via the internet.

6. The system of claim 5, wherein the fraud protection computer determines whether the prospective purchase is authorized by further evaluating whether the IP address used by the purchasing computer corresponds to an IP address associated with the owner of the payment account being used to purchase the goods or services.

7. The system of claim 5, wherein the fraud protection computer receives the request to verify from a purchasing computer with an IP address that is not associated with the owner of the payment account being used to purchase the goods or services.

8. The system of claim 1, wherein the message to the payment account owner's communication device requires the user to enter a predetermined passcode to indicate that the purchase is authorized.

9. The system of claim 1, wherein the fraud protection computer sends an indication that the purchase is not authorized when a predetermined time period passes after initiating the message to the payment account owner's communication device without receiving a response.

10. The system of claim 1, wherein
the fraud protection computer also receives a request to approve the purchase; and
the fraud protection computer determines whether the purchase is approved.

11. The system of claim 10, wherein the fraud protection computer initiates a message indicating whether the purchase is approved no more than two (2) minutes after the fraud protection computer receives the request to approve the purchase.

12. The system of claim 1, wherein the fraud protection computer initiates a message indicating whether the owner of the payment account being used to purchase the goods or services authorizes the purchase no more than two (2) minutes after the fraud protection computer receives the request to verify whether the owner of the payment account being used to purchase the goods or services authorizes the purchase.

13. A method, comprising:
obtaining information identifying the owner of a payment account offered to purchase goods or services over the internet from a prospective purchaser;
searching a database using a computer and identifying a telephone number associated with the owner of the payment account offered for the purchase;
sending a message to the telephone associated with the owner of the payment account offered for purchase requesting the telephone's user to respond to the message if the purchase is authorized;
sending a message approving the purchase if at least an appropriate response is received; and
sending a message denying the purchase if an appropriate response is not received.

14. The method of claim 13, wherein the sending a message to the telephone associated with the owner of the payment account includes sending a message over a wireless telephone network to the wireless telephone associated with the owner of the payment account.

15. The method of claim 14, wherein the sending a message to the telephone associated with the owner of the payment account includes sending a text message to the wireless telephone associated with the owner of the payment account.

16. The method of claim 13, wherein the sending a message to the telephone associated with the owner of the payment account includes requesting the telephone's user to respond with a previously established password if the purchase is authorized.

17. The method of claim 13, wherein the message to the telephone associated with the owner of the payment account is sent over a telephone network, and the message is delivered to the payment account owner's telephone no more than one (1) minute after the obtaining information identifying the owner of the payment account.

18. A method, comprising the acts of:
receiving information identifying a payment account offered by a prospective purchaser when attempting to make a purchase;
identifying a communication device address associated with the owner of the payment account offered for purchase, the identifying being done with a computer and being done independently of receiving the communication device address from the prospective purchaser during the purchase request;
sending a message to the communication device associated with the owner of the payment account offered for purchase;
requesting a response from the communication device associated with the owner of the payment account offered for purchase;
authorizing the purchase if at least a response corresponding to criteria established before the receiving is received; and
denying the purchase if a response corresponding to criteria established before the receiving is not received.

19. The method of claim 18, wherein the sending a message to the communication device associated with the owner of the payment account includes sending a message over a wireless telephone network to the wireless telephone associated with the owner of the payment account.

20. The method of claim 19, wherein the sending a message to the communication device associated with the owner of the payment account includes sending a text message to the wireless telephone associated with the owner of the payment account.

21. The method of claim 18, wherein the information identifying a payment account is received via the internet from the prospective purchaser when attempting to make a purchase over the internet.

22. The method of claim 18, further comprising requiring the user of the communication device associated with the owner of the payment account to enter a password if the user desires to indicate that the purchase is authorized.

23. The method of claim 18, further comprising delivering the message to the communication device associated with the owner of the payment account offered for purchase less than one (1) minute after the receiving of information identifying the payment account.
